(19) United States
(12) Patent Application Publication
(10) Pub. No.: US 2026/0348552 A1
(43) Pub. Date: Nov. 5, 2026

(54) LIGHT-EMITTING DEVICE CONFIGURED TO PERFORM AT LEAST TWO LUMINOUS FUNCTIONS

(71) Applicant: VALEO VISION, Bobigny (FR)

(72) Inventors: Marine COURCIER, Bobigny (FR); Pierre ALBOU, Bobigny (FR)

(73) Assignee: VALEO VISION, Bobigny (FR)

(21) Appl. No.: 19/125,396

(22) PCT Filed: Oct. 30, 2023
(86) PCT No.: PCT/EP2023/080268

§ 371 Date: Apr. 29, 2025

(30) Foreign Application Priority Data
Oct. 30, 2022 (FR) FR2211337

(51) Int. Cl. F21V 5/00

(52) U.S. Cl. CPC F21V 5/007

(57) ABSTRACT

The invention relates to a light-emitting device with selectively addressable light sources, a collimator common to the plurality of light sources and a matrix-array microlens device with a mask interposed between an entrance matrix array of microlenses and an exit matrix array of microlenses. The collimator being configured to shape the light rays emitted by a light source into a beam of substantially parallel rays delivered to the matrix-array device, with an angle of inclination that differs depending on the light source activated, at least one channel for passage of light being defined at one longitudinal end by a single entrance microlens, which is configured to focus the beams of parallel rays into a focal region on the mask, the focal region differing depending on the angle of inclination, the mask comprising a plurality of apertures respectively placed in one of the focal regions.

### TECHNICAL FIELD

The present invention relates to the field of luminous devices, in particular luminous devices with which a motor vehicle is able to be equipped. The present invention more particularly relates to such luminous devices able to generate a plurality of luminous functions, and for example a lighting luminous function and a signaling luminous function.

### BACKGROUND OF THE INVENTION

Vehicles, and in particular motor vehicles, are commonly equipped with lamps making it possible to generate various luminous functions, such as a function allowing the road to be illuminated or a function allowing the vehicle to signal to other road users, such signaling functions comprising DRL functions (DRL standing for Daytime Running Light) or indeed indicator-light functions allowing a change of direction to be indicated.

In certain applications, light rays emitted by a light source are directed into a microlens array (MLA) with a view to forming a beam allowing a luminous function to be performed.

The microlens array comprises an array of entrance microlenses, an array of exit microlenses and a mask interposed between these arrays. The microlens array is configured to form light-guiding channels between one of the entrance microlenses and one of the exit microlenses, the mask comprising mask segments each of which is placed in one respective light-guiding channel. Each mask segment is provided with at least one aperture able to let light rays pass from the entrance microlens to the exit microlens. The apertures in the mask are configured to give a shape to the rays transmitted by the array of entrance lenses and to allow the array of exit lenses to project this shape onto the road.

Moreover, vehicles, and more particularly motor vehicles, have lamps that are increasingly compact and within which the same luminous module is able to generate a plurality of luminous functions and in particular a lighting function and a signaling function.

### SUMMARY OF THE INVENTION

In this context, it is sought to emit light beams specific to each of the luminous functions generated by the module through the same lighting area. In other words, with the aim of giving the lighting of a vehicle a visual identity, it is desired for an exterior observer outside the vehicle to see the same area illuminated, irrespectively of whether the lamp is performing a lighting or signaling function.

The microlens arrays of the prior art are unable to meet such requirements, insofar as a single light source is placed in front of the array of entrance microlenses. However, the inventors wish to be able to implement such a microlens array insofar as these devices allow greater flexibility in the shape of the functional lighting area, and therefore flexibility in the style of the lamp equipped with the microlens array, achieved by virtue of a discretization per unit area of the entrance and exit microlenses.

In this context, the present invention provides a luminous device comprising at least light-emitting means, a collimator and a microlens array, the light-emitting means being configured to emit light rays in the direction of the microlens array via the collimator, the microlens array comprising at least an array of entrance microlenses, an array of exit microlenses, and a mask interposed between the two arrays of microlenses, and a main optical axis secant to the two arrays of microlenses, the microlens array being configured to form light-guiding channels that are respectively arranged along the main optical axis between at least one entrance microlens and one exit microlens, the mask comprising mask segments that are each placed in one respective light-guiding channel. According to the invention, the light-emitting means comprise a plurality of selectively addressable light sources, the collimator being common to the plurality of light sources and configured to shape the light rays emitted by a light source into a beam of substantially parallel rays directed in the direction of the microlens array, a tilt angle of the beam of substantially parallel rays with respect to the optical axis differing depending on the light source activated. Moreover, at least one light-guiding channel is arranged along the main optical axis and is bounded at one longitudinal end by a single entrance microlens, which is configured to focus the beams of substantially parallel rays onto a focal zone on the mask segment, which is placed in the light-guiding channel and the position of which on the mask segment differs depending on said tilt angle of the beam of substantially parallel rays, the single entrance microlens thus being configured to direct the rays onto various focal zones depending on said tilt angle of the beam of substantially parallel rays, the mask segment placed in said at least one light-guiding channel comprising a plurality of apertures each placed in a respective one of the focal zones.

The light sources are said to be selectively addressable insofar as they may be activated independently of one another, by an electronic control device. By way of example, when one of the light sources is activated, the one or more other light sources may be deactivated so that only one light source is able to emit light rays. Alternatively, in order to increase the uniformity of the turned-on appearance of the area depending on the activation of the lights, it may be envisioned to leave a source associated with a specific function on while another source is turned on. In other words, in certain cases, at least some of the light sources, and in particular all of the light sources, may be turned on simultaneously, this making it possible to simultaneously generate the respective associated luminous functions. When all of the sources are turned on at the same time, it is possible for certain sources to be turned on at variable light-intensity levels, for example.

Advantageously, all of the light sources are configured to illuminate substantially the same zone of the array of entrance microlenses. In other words, the light spots generated by the light sources on the array of entrance microlenses have substantially identical outlines, such that said light spots largely superpose. Potential differences may exist due to the offset between the positions of the various light sources. By “largely superpose” what is meant is that more than 75%, and in particular more than 90%, of the area of each light spot is common with at least one light spot generated by another light source of the luminous device.

Advantageously, each light source is configured to illuminate the entire array of entrance microlenses.

The light sources may in particular be light-emitting diodes.

Each entrance and exit microlens comprises a curved surface turned toward the exterior of the microlens array, and the thickness of material that extends from the curved surface to the mask, the mask forming the limit between the array of entrance microlenses and the array of exit microlenses. The channels are defined to be a band of the material of the microlens array formed by an entrance microlens and an exit microlens arranged facing the entrance microlens if the main optical axis is considered, there being within the microlens array no structural elements, such as a partition for example, generating a physical boundary between two neighboring channels.

The dimensions of the constant cross section of a light-guiding channel are in particular defined by the corresponding dimensions of the entrance microlens.

The mask comprises a plurality of mask segments each of which is equipped with a respective plurality of apertures, such that each of the light-guiding channels comprises one aperture-containing mask segment.

If the light guided in a guiding channel encounters one of the apertures formed in the mask segment present across this guiding channel, the light is able to propagate to the array of exit microlenses, this allowing a luminous function to be performed. If this light originates from a first light source a first luminous function may be performed, and if this light originates from a second light source a second luminous function may be performed, or an additional segment of the first luminous function allowing a specific luminous function to be generated through combination of these two segments may be formed. In both cases, the light participating in performing the luminous function exits from a common lighting area formed by the array of exit microlenses.

The luminous device has a main optical axis, the first and second luminous functions being emitted on the whole along this main axis. In other words, the light beams of the first and second luminous functions each extend into a volume containing said main optical axis.

The array of entrance microlenses and the array of exit microlenses may both be perpendicular to the main optical axis. In this case, the light-guiding channels are respectively arranged along the main optical axis, i.e. parallel to this axis.

The array of entrance microlenses and the array of exit microlenses may both be tilted with respect to the main optical axis, i.e. the median virtual surfaces on which said arrays of microlenses respectively rest are tilted with respect to a plane perpendicular to said axis. In a first configuration, relative to the main optical axis, each exit microlens is laterally offset with respect to the respective entrance microlens associated therewith, to define a light-guiding channel. In this configuration, each of the light-guiding channels is tilted with respect to the main optical axis. In another configuration, relative to the main optical axis, certain sets of entrance and exit microlenses respectively associated to define a light-guiding channel are respectively offset axially with respect to at least one of the adjacent sets. Thus, there are steps present on the external faces of the array of entrance microlenses and of the array of exit microlenses, these steps generating an overall tilt of these arrays. In this configuration, the light-guiding channels are respectively arranged along the main optical axis, i.e. parallel to this axis. It will be noted that said median virtual surfaces may be planar or curved.

According to the invention, a plurality of distinct light beams are thus projected onto the same lighting area, namely the array of exit microlenses, rays focused by the entrance microlenses being made to pass through first apertures of the mask when a first luminous function is desired, and rays focused by the entrance microlenses being made to pass through other apertures of the mask when another luminous function is desired. It will be understood that when focused rays are said to be made to pass through an aperture, certain marginal rays may not follow the theoretical path of the light rays and for example be blocked by an opaque segment of the mask.

The microlens array according to the invention thus makes it possible to easily and precisely perform various luminous functions with one and the same lighting area, the mask being made using lithography to produce various types of apertures specific to the embodiment of the luminous function in question.

The collimator is configured to reorient the rays passing through it so as to form, as output, a beam of rays that are parallel to one another, and thus to uniformly direct these light rays toward the microlenses of the array of entrance microlenses. After passing through the collimator, the light rays emitted by each of the selectively addressable light sources are thus directed uniformly onto each of the entrance microlenses. The collimator is configured to direct the rays into a beam of parallel rays that strikes the entrance microlenses at an angle of incidence that is specific to the activated light source and therefore to the luminous function that it is desired to implement with the luminous device.

In other words, the collimator is configured to direct the light rays emitted by a first light source toward the microlens array in a first beam of parallel rays and to direct the light rays emitted by another light source toward the microlens array in another beam of parallel rays, the other beam of parallel rays having a tilt with respect to the optical axis that is different from the corresponding tilt of the first beam of parallel rays.

The array of entrance microlenses and the array of exit microlenses are composed of microlenses the dimensions of which are of the order of one millimeter, and between 0.3 mm and 5 mm.

More particularly, according to one advantageous embodiment of the invention, the projecting microlenses all have a size, in respect of their diameter, height and/or width, seen from in front, smaller than or equal to 10 mm. This makes it possible to limit the thickness of the microlenses, and thus to limit the weight of the part. Moreover, according to one advantageous embodiment of the invention, the projecting microlenses all have a size, in respect of their diameter, height and/or width, seen from in front, larger than or equal to 0.3 mm. This makes it possible to manufacture the optical device using a simple to implement injection-molding process. According to one advantageous embodiment of the invention, the projecting lenses all have a size, in respect of their diameter, height and/or width, seen from in front, of between 0.5 and 5 mm. This allows the projecting lenses to be made small enough not to be seen at the usual observation distance.

According to one optional feature of the invention, the at least one light-guiding channel is arranged along the main optical axis and is bounded at one longitudinal end by a single entrance microlens and at the other longitudinal end by a plurality of exit microlenses.

According to one optional feature of the invention, the exit microlenses placed at one longitudinal end of a light-guiding channel are adjacent. Where appropriate, the adjacent exit microlenses may lie in planes of elongation that are offset and parallel to one another, with a step formed from one exit microlens to another.

According to one optional feature of the invention, at least one dimension of an entrance microlens participating in bounding a light-guiding channel is a multiple of a corresponding dimension of the exit microlenses participating in bounding this light-guiding channel. By way of example, when a light-guiding channel extends between one entrance microlens and two exit microlenses, a dimension of the entrance microlens, projected into the vertical and transverse plane of elongation, is equal to the sum of the corresponding dimensions, projected into the same plane, of the two adjacent exit microlenses.

According to one optional feature of the invention, the exit microlenses of a given light-guiding channel are configured to have object focal points positioned differently on the mask segment present in this light-guiding channel, an object focal point of an exit microlens being specifically associated with one aperture in the mask segment.

According to one optional feature of the invention, within a light-guiding channel, the number of apertures that are different from one another within a mask segment is equal to the number of exit microlenses present at one longitudinal end of this light-guiding channel.

According to one optional feature of the invention, the number of apertures that are different from one another within a mask segment is equal to the number of different light sources.

According to one optional feature of the invention, the apertures present within a given mask segment, in a light-guiding channel, are of different shapes and/or sizes.

According to one optional feature of the invention, the pattern formed in a mask segment by the apertures of different shapes and/or sizes is identical for each mask segment. In other words, the various apertures are placed alternately on the mask in at least one main direction of elongation.

According to one optional feature of the invention, the apertures comprise two types of apertures, with first apertures and second apertures being placed alternately on the mask in at least one main direction of elongation. The microlens array mainly lies in a plane dependent on two main directions of elongation, perpendicular to the main optical axis, and each array of entrance or exit microlenses is formed from microlenses arranged in rows and columns formed in these two main directions of elongation. The apertures of the various types may be alternated in one of the directions of elongation and in both directions.

According to one optional feature of the invention, the luminous device comprises a first light source activation of which participates in generating a first luminous function and a second light source activation of which participates in generating a second luminous function or an additional segment of the first luminous function, light rays emitted by the first light source being intended to be focused by the entrance microlens of a light-guiding channel onto a first focal zone located on a first aperture of the mask segment that is placed in this light-guiding channel, light rays emitted by the second light source being intended to be focused by the same entrance microlens onto a second focal zone located on a second aperture of the same mask segment.

It will be noted that by “participates in generating” what is meant is that the luminous device according to the invention may be a single device allowing the desired lighting or signaling beam to be produced or indeed that the light beam generated by this luminous device may be combined with other light beams generated by other luminous devices to form said beam, irrespectively of whether these other luminous devices are according to the invention or not.

More particularly, the collimator and the entrance microlenses are configured such that the light rays passing through a given entrance microlens are intended to pass through the same mask segment within the light-guiding channel downstream of this entrance microlens, and essentially through a first aperture when the rays are emitted by a first light source and essentially through a second aperture when the light rays are emitted by a second light source.

According to one optional feature of the invention, each mask segment comprises first apertures and second apertures associated with a first focal zone and a second focal zone, respectively, and characterized in that at least one of the first apertures and at least one of the second apertures has a different shape and/or size from the other first apertures and other second apertures, respectively.

Thus, it will be understood that the invention also covers cases where the windows formed by the apertures may differ from one mask segment used for a given function to another, for example in order to achieve more precise control inside the overall light beam generated. By way of example, windows of different widths allow good precision to be achieved in the variation in photometric values over a horizontal cross section of the beam.

According to one optional feature of the invention, the first light source and the second light source are spaced apart from each other, being distributed on either side of a defined plane, the first light source being closer to said defined plane than the second light source. The first source may, where appropriate, be placed partly on this defined plane. The defined plane in question is a plane substantially perpendicular to both/either of the arrays of microlenses and it comprises the main optical axis of the luminous device. This defined plane may in particular be a median plane, and where appropriate a plane of symmetry, of the collimator. By spaced apart from each other, what should be understood is that the light sources do not make contact with each other and are sufficiently far apart, there being a space therebetween of about 0.5 to 2 times the size of the light source for example, for the rays to be able to have a different tilt on exiting the collimator, depending on which of the light sources they are emitted by.

According to one optional feature of the invention, the object focal point of one of the exit microlenses specifically associated with a first aperture is placed substantially on a border bounding said first aperture. This feature is in particular implemented in guiding channels that are intended to be passed through by light rays participating in forming a lighting function, and in particular a low-beam function, for which it is desired to have a clear cut-off in the beam, the beam then being cut off by said border bounding the aperture on which the mentioned focal point is placed.

According to one optional feature of the invention, the border of said first aperture, on which the object focal point of one of the exit microlenses is placed, contains a kink.

According to one optional feature of the invention, the object focal point of an exit microlens specifically associated with a second aperture is placed substantially at the center of said second aperture. By “substantially at the center”, what should be understood is that this object focal point is placed far from an edge bounding the second aperture, this for example including a position in which the object focal point is arranged two thirds of a distance between two opposite edges bounding this second aperture. This feature is in particular implemented in guiding channels that are intended to be passed through by light rays participating in forming a signaling function.

According to one optional feature of the invention, the mask is formed by a glass sheet comprising at least one opaque layer deposited on one face of the glass sheet, the apertures being formed by holes in this opaque layer. More particularly, the opaque layer is deposited on the face of the glass sheet that faces the array of entrance microlenses.

According to one optional feature of the invention, the number of different types of aperture is equal to the number of different light sources. Moreover, the number of exit microlenses associated with the same entrance microlens and with an associated light-guiding channel is equal to the number of different light sources. By way of example: if provision has been made for two luminous functions, with two light sources located facing a common collimator, two types of apertures are produced in the mask, one aperture of each of these types of apertures being present in every given mask segment, i.e. in every given light-guiding channel between an entrance microlens and two exit microlenses. When a first light source is activated, the light rays are focused by each entrance microlens into their associated guiding channel and onto first zones of the mask segment present in this channel, each first zone corresponding to a first aperture, or aperture of the first type, formed in the mask segment. When the second light source is activated, the light rays are focused by each entrance microlens into their associated guiding channel and onto second zones of the mask segment present in this channel, each second zone corresponding to a second aperture, or aperture of the second type. Within each mask segment, the second zones are offset with respect to the first zones in the direction in which the light sources are offset with respect to each other. It will be noted that each of the zones onto which the light rays are liable to be directed after having passed through an entrance microlens is located in an aperture, or on the border of an aperture, such that the light rays may propagate in the direction of one of the exit microlenses. Thus, no or few light rays are blocked within the microlens array and no luminous intensity is lost, in particular in the case of implementation of a signaling function. To provide a lighting function of low-beam type requiring the beam to be given a shape different from that of the light spot, one portion of the light rays is cut off. It will be understood that, in the latter case, few light rays other than those intended to be cut off with the cut-off shape defined by the edges bounding the specific aperture in the mask are here blocked.

According to one optional feature of the invention, the exit microlenses associated with a light-guiding channel equipped with a mask segment with an aperture of the first type have an optical axis the relative position of which within the light-guiding channel is distinct from the corresponding relative position of the optical axis of the exit microlenses associated with a light-guiding channel equipped with a mask segment with an aperture of the second type.

Thus, provision of an exit microlens that is off-centered so that its center is aligned with the aperture or with the edge of the aperture participates in suitably deflecting the light rays.

According to one optional feature of the invention, the entrance microlenses and exit microlenses have a respective external surface, in particular a respective curved external surface, that is turned toward the exterior of the microlens array, and the microlens array is configured to have an exit surface, formed by the plurality of external surfaces of the exit microlenses, that is tilted with respect to a longitudinal direction along which the main optical axis of the luminous device extends.

To this end, the entire microlens array, and the light-guiding channels also, may be tilted with respect to this main optical axis, the external surfaces of the exit microlenses lying in a plane substantially parallel to the plane in which the external surfaces of the entrance microlenses lie. The microlenses, and in particular the exit microlenses, are then configured to steer the light rays toward the main optical axis of the luminous device.

Alternatively, the array of entrance microlenses and the array of exit microlenses remain in a vertical and transverse plane perpendicular to a longitudinal direction L along which the main optical axis 10 of the luminous device 1 extends, the light-guiding channels keeping this orientation parallel to the optical axis, and it is the external surfaces of the entrance microlenses that are axially offset with respect to one another, so as to form transverse rows that are axially offset from one another and therefore stair steps that create the tilt effect when the screen as a whole is viewed.

The invention also relates to an automotive vehicle comprising at least one luminous device in accordance with what has just been described above.

### BRIEF DESCRIPTION OF DRAWINGS

Other features, details and advantages of the invention will become more clearly apparent on reading, on the one hand, the following description, and on the other hand, examples of embodiment that are given by way of indication and non-limitingly with reference to the appended schematic drawings, in which:

FIG. 1 illustrates a luminous device according to the present invention in such a way as to show its light sources, a collimator common to these light sources and a microlens array that in particular comprises an array of entrance microlenses, a mask and an array of exit microlenses;

FIG. 2 shows in perspective the components of the microlens array of FIG. 1, with the mask arranged between the arrays of microlenses;

FIG. 3 shows a detailed view of a segment of the mask of the microlens array of FIG. 1, allowing two apertures of distinct shapes and/or sizes within this mask segment to be seen;

FIG. 4 shows a general view of the luminous device according to the invention performing a first luminous function, with the light rays that propagate through the luminous device when a first light source is activated shown schematically;

FIG. 5 shows a local view of the microlens array, the view being centered on a light-guiding channel between an entrance microlens and two adjacent exit microlenses, the luminous device performing the first luminous function as illustrated in FIG. 4;

FIG. 6 shows a general view of the luminous device according to the invention performing a second luminous function, with the light rays that propagate through the luminous device when a second light source is activated shown schematically; and

FIG. 7 shows a local view of the microlens array, the view being centered on the light-guiding channel illustrated in FIG. 5, the luminous device performing the second luminous function as illustrated in FIG. 6.

### DETAILED DESCRIPTION OF THE INVENTION

It should first be noted that while the figures show the invention in detail to enable the invention to be carried out, these figures may of course be used to better define the invention where appropriate. It also should be noted that these figures merely disclose examples of embodiment of the invention.

The features, variants and different embodiments of the invention may be combined with one another, in various combinations, provided that they are not mutually incompatible or exclusive. Notably, it is possible to envisage variants of the invention that comprise only a selection of features described below, independently of the other features described, if this selection of features is sufficient to confer a technical advantage or to differentiate the invention from the prior art.

In the figures, elements common to a number of figures have been designated by the same reference sign in all of them.

In the following description, reference will be made to orientations with respect to longitudinal, vertical and transverse axes such as defined by the system of axes L, V, T shown in FIGS. 1 to 7, with the longitudinal axis L corresponding to the general direction of propagation of the light rays and the vertical and transverse axes V, T defining a main plane of elongation of the microlens array forming part of the luminous device, the vertical and transverse axes being perpendicular to the longitudinal axis L. More particularly, the vertical axis V and the transverse axis T respectively correspond to the height and width of windows produced in a mask such as will be described below in more detail, these windows having a width larger than their height. The choice of designations of these axes does not limit the orientation that the luminous device can adopt, in particular when the latter is installed in an automotive vehicle.

FIG. 1 schematically illustrates a luminous device 1 comprising a microlens array 2, a collimator 3 and light-emitting means 4.

The light-emitting means 4 comprise a plurality of light sources that, in the embodiment shown, are two in number, namely a first light source 41 and a second light source 42. As will be described below, the number of light sources may vary provided that the microlens array is configured accordingly. Each of the light sources is selectively addressable. Here, each of the first and second light sources 41, 42 is thus capable of switching on and switching off independently of the other, for example by means of an electronic control device.

The light sources 41, 42 are placed on either side of a defined plane comprising a main optical axis 10 of the luminous device. In the illustrated example, the first light source 41 and the second light source 42 are distributed on either side of this defined plane, the distance of each of the light sources from the defined plane being variable depending on the luminous function that these light sources participate in performing. As will be described below, the distance of the light sources from the defined plane is determined depending on the angle with respect to the main optical axis 10 that it is desired to give to the light rays exiting from the collimator when each of the light sources is activated. Thus, the light sources are spaced apart from each other, in the vertical direction, as illustrated in FIG. 1 in particular, but also in the transverse direction depending on the number and arrangement of the light sources. By “spaced apart from each other”, what is meant is that the light sources do not make contact with each other.

The collimator 3 and the light-emitting means 4 are positioned with respect to each other so that the light rays emitted by each of the light sources 41, 42 pass through the collimator 3. This collimator 3 is configured to capture light rays emitted by each of the light sources, here the first light source 41 or the second light source 42, and to orient them substantially parallel to one another and to direct them toward the microlens array 2, and more specifically toward an array of entrance microlenses 21.

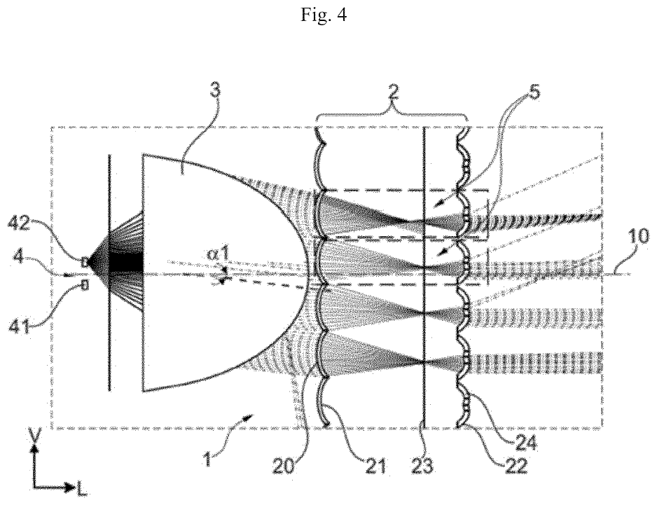

The collimator 3 is more particularly configured to form beams of rays that are parallel or substantially parallel to one another, these beams being specific to activation of each of the light sources. By “substantially parallel” what is meant is that the rays may have an angular offset related to the size of the light source generating them. In other words, the collimator 3, which takes the form of a lens, is configured to deliver, as output, in the direction of the microlens array 2, a first beam of parallel rays when a first light source 41 is activated (see FIG. 4), the rays mainly having a tilt angle with respect to the optical axis of a first value, as will be explained below with reference to FIG. 4. Furthermore, this collimator 3 is configured to deliver, as output, a completely different beam of parallel rays, i.e. a beam with a different tilt, if the activated light source is changed. The collimator is then able to deliver, as output, in the direction of the microlens array 2, another beam of parallel rays when another light source is activated, all (or almost all) of the rays having a tilt angle with respect to the optical axis of another value different from the first value, as will be explained below with reference to FIG. 6.

The microlens array 2 comprises said array of entrance microlenses 21, an array of exit microlenses 22 and a mask 23 interposed between the array of entrance microlenses 21 and the array of exit microlenses 22. In the illustrated example, each array of microlenses 21, 22 and the mask 23 mainly lie in a vertical and transverse plane, perpendicular to a longitudinal direction L along which the main optical axis 10 of the luminous device 1 extends. Alternatively, the microlens array may adopt a tilted position with respect to the main optical axis, in particular in order to adapt to a curvature of the vehicle into which it must be integrated. This tilted position may be obtained by tilting the microlens array in its entirety or indeed by forming steps in the exit surface of the microlens array formed by an external surface of the array of exit microlenses.

The exit surface of the microlens array, i.e. the external surface of the array of exit microlenses 22, forms a lighting area of the luminous device 1, i.e. an area through which the light rays exit to generate a light beam outside the vehicle, that is common to each of the luminous functions capable of being performed by the luminous device.

Each array of entrance and exit microlenses has an external surface turned away from the mask, and an internal volume formed by the thickness of material extending from the external surface to the mask, the mask forming the limit between the array of entrance microlenses and the array of exit microlenses.

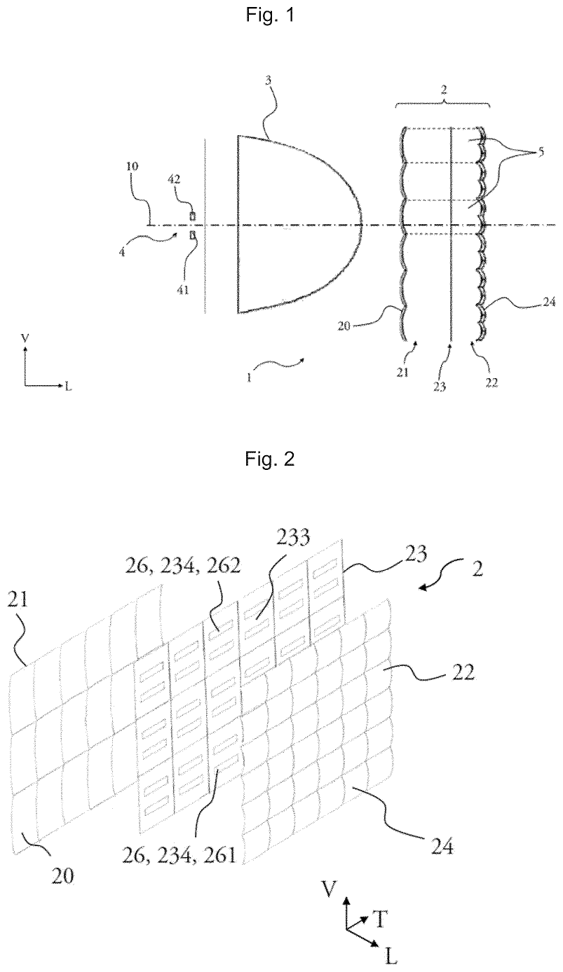

The array of entrance microlenses 21 is formed from a plurality of entrance microlenses 20 that are juxtaposed next to one another, both in the vertical direction, as can be seen in FIG. 1, and in the transverse direction, as can be seen in FIG. 2. These entrance microlenses each have a curved surface the juxtaposition of which surface, where appropriate with a longitudinal offset that generates a step from one curved surface to another, forms the external surface of the array of entrance microlenses, and they each have a thickness of material extending between the curved surface and the mask in order to be able to propagate light from one to the other.

It will be noted that, in the figures schematically showing the microlens array, only the external surface of the entrance and exit microlenses has been shown; however, it will further be noted that each microlens is not just formed by the curved surface but indeed comprises the thickness of material running from this curved surface to the mask, or to the mask carrier when there is one.

Each entrance microlens 20 is configured within the microlens array 2 such that it has an image focal point on the mask 23. Light rays coming from the collimator 3 and passing through an entrance microlens 20 converge toward a focal point present on the mask 23. In the illustrated example, the entrance microlenses 20 are identical to one another.

In projection in a plane perpendicular to the main optical axis 10, the entrance microlenses 20 all have a size, in respect of their diameter, height and/or width, seen from in front, smaller than or equal to 10 mm and larger than or equal to 0.3 mm. More particularly, provision may be made for entrance microlenses that all have a size, in respect of their diameter, height and/or width, seen from in front, of between 0.5 and 5 mm.

Equivalently to the arrangement of the array of entrance microlenses 20, the array of exit microlenses 22 is formed from a plurality of exit microlenses 24 that are juxtaposed next to one another, both in the vertical direction, as can be seen in FIG. 1, and in the transverse direction, as can be seen in FIG. 2.

These exit microlenses each have a curved surface the juxtaposition of which surface, where appropriate with a longitudinal offset that generates a step from one curved surface to another, forms the external surface of the array of exit microlenses, i.e. the exit surface of the microlens array, and they each have a thickness of material extending between the mask and the curved surface in order to be able to propagate light from one to the other.

It will be noted that, in the figures schematically showing the microlens array, only the external surface of the entrance and exit microlenses has been shown; however, it will further be noted that each microlens is not just formed by the curved surface but indeed comprises the thickness of material running from this curved surface to the mask, or to the mask carrier when there is one.

Each exit microlens 24 is configured within the microlens array 2 such that it has an object focal point on the mask 23. The light rays propagating within the microlens array and passing through this object focal point are re-oriented by the corresponding exit microlens 24 into a light beam that is projected toward the exterior of the vehicle in order to participate in forming a lighting beam on the road scene or a signaling beam.

In projection in a plane perpendicular to the main optical axis 10, the exit microlenses 24 have, in a vertical direction, a height and, in a transverse dimension, a width of between 0.3 and 10 mm. It will be noted that the value of the height of an entrance microlens is a multiple of the value of the height of an exit microlens and that the width of an entrance microlens is similar to the width of an exit microlens. In the illustrated embodiment, the value of the height of an entrance microlens is more particularly twice the value of the height of an exit microlens. Without departing from the context of the invention, in particular if the light sources are placed on either side of a plane defined in a transverse direction, the value of the width of an entrance microlens could be a multiple of the value of the width of an exit microlens.

The result of the above is that each entrance microlens 20 has at least one dimension in one direction that is larger than the corresponding dimension of the exit microlenses 24. In the illustrated example, for example and without limiting the invention, it is the height of an entrance microlens, along the vertical axis V, that is larger than the height of an exit microlens, along the same axis, the widths being equivalent.

The microlens array 2 according to the invention is configured to comprise, within it, light-guiding channels 5 that each extend in a direction parallel to that of the main optical axis 10, between one entrance microlens 20 and a plurality of adjacent exit microlenses 24. The number of adjacent exit microlenses 24 participating in bounding a given light-guiding channel depends on the number of different light sources that are capable of being activated facing a given collimator. In the illustrated example, in which two light sources have been provided, each light-guiding channel 5 extends between one entrance microlens 20 and two adjacent exit microlenses 24, among which a first entrance microlens 241 and a second exit microlens 242 have been shown. It will be understood that the dimension of the entrance microlens that is larger than that of the exit microlenses has the effect of covering the whole light-guiding channel with a single entrance microlens 20 while the latter opens onto two exit microlenses 241, 242.

The light rays shaped by the collimator pass through an entrance microlens 20, then propagate essentially through the light-guiding channel 5 associated with this entrance microlens 20 and emerge from the microlens array 2 essentially via one of the exit microlenses 24 associated with this light-guiding channel, provided that they were able to pass through the mask 23 placed across the light-guiding channel 5.

As will be described in more detail below, the exit microlenses 24 may have a different configuration depending on the light-guiding channel 5 in which they are arranged. In particular, certain exit microlenses 24 may have, relative to the light-guiding channel to which they belong and to the luminous function that they must participate in generating, a symmetric or asymmetric configuration, or more particularly a centered or off-centered configuration, an optical axis of the exit microlens being coincident with or offset from a median axis of the associated light-guiding channel.

Each light-guiding channel 5 comprises one segment of the mask 23 transecting the microlens array between the array of entrance microlenses 21 and the array of exit microlenses 22, the mask 23 consisting of a plurality of mask segments 231 that are juxtaposed with one another and each of which is placed in a respective light-guiding channel 5 that is specific thereto.

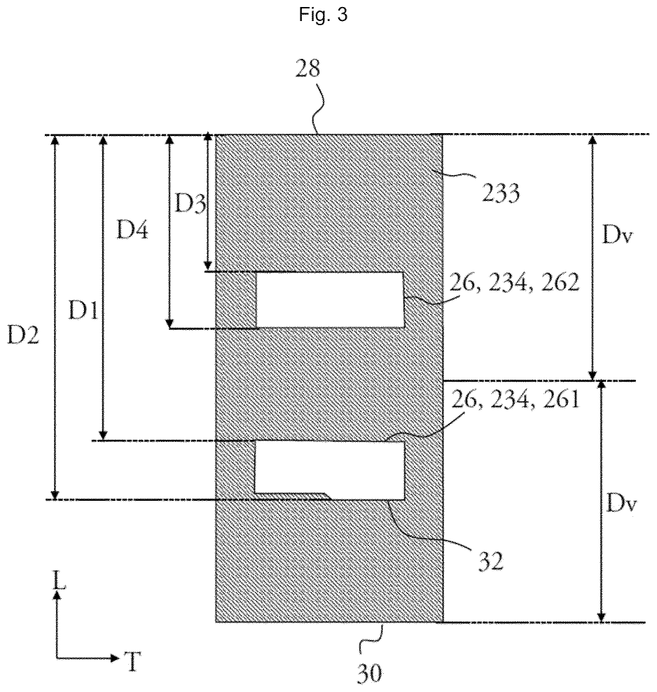

Each mask segment 231 associated with a light-guiding channel comprises a plurality of apertures 26 (in particular shown in FIGS. 2 and 3) via which the rays deviated by the entrance microlens 20 associated with this light-guiding channel are able to pass in order to continue their propagation through the microlens array 2 in the direction of one of the exit microlenses, the light rays passing through one of the apertures being directed toward one of the exit microlenses while the light rays passing through another of the apertures are directed toward another of the exit microlenses.

Each mask segment 231 thus comprises a respective opaque portion 233, which blocks propagation of the light rays when they encounter this opaque portion, and a transparent portion 234, which is formed by the apertures 26, and which allows propagation of the light rays that encounter this transparent portion.

For a given light-guiding channel, each exit microlens 24 is configured to have an object focal point positioned in one of the apertures 26 forming the transparent portion 234 of the mask segment 231. More particularly, for a light-guiding channel in which the exit microlenses are placed side by side in a first direction, here the vertical direction, the apertures 26 formed in a given mask segment 231 are spaced apart from one another in the same first direction. Each exit microlens 24 is then configured to have an object focal point positioned in the aperture facing this exit microlens. As will be described below, the object focal point of the exit microlenses 24 may be positioned in a central position of the aperture 26 or in an off-centered position, and in particular on an edge bounding the aperture 26.

In the aforementioned context of entrance microlenses 20 focused on the mask, it will be understood that if the light rays focused by the entrance microlens 20 of a light-guiding channel 5 are directed onto a first aperture 261 participating in forming the transparent portion 234 of the mask segment 231 placed across the light-guiding channel, the light is directed toward a first exit microlens 24 placed facing this first aperture, whereas if the light rays focused by the entrance microlens 20 of this light-guiding channel 5 are directed onto a second aperture 262 participating in forming the transparent portion 234 of the same mask segment 231, the light is directed toward a second exit microlens 24 placed facing this second aperture. This will more particularly be described below with reference to FIGS. 4 to 7.

The microlens array is made of a transparent material, the mask 23 being formed by a glass sheet surrounded by a plastic material, the glass sheet comprising at least one opaque layer deposited on one face of the glass sheet, the opaque layer being patterned, for example using a laser cutting operation, to produce each of the apertures 26 within each of the mask segments.

The patterned portions thus form the transparent portion 234 of the mask segments 231 and the rest forms the opaque portion 233.

The position of the mask 23 within the microlens array 2, as illustrated in FIG. 1 and FIGS. 4 and 6, is given here by way of indication. The mask 23 could, without departing from the context of the invention, be moved along the main optical axis 10 toward the entrance microlens array 21 or exit microlens array 22, provided the microlenses are configured so as to have a focal point on the mask as described above.

Moreover, the position of the mask takes into account the thickness, i.e. the dimension along the longitudinal axis L, of the array of entrance microlenses and the thickness of the array of exit microlenses, the thickness of the entrance microlenses possibly being at least twice as large as the thickness of the exit microlenses insofar as there are two exit microlenses per entrance microlens in each channel.

As mentioned, and as may be seen in FIGS. 2 and 3, a mask segment 231 comprises a plurality of apertures 26 placed apart from one another such that an opaque segment 233 is interposed between them. The apertures formed within a given mask segment are offset from one another in the same direction as the exit microlenses bounding the light-guiding channel in which said mask segment is placed. Moreover, the apertures differ from one another in their shape and/or their dimensions.

In the illustrated example, a mask segment 231 comprises two apertures placed vertically at a distance from each other, i.e. a first aperture 261 and a second aperture 262. The mask segment 231 has a vertical dimension Dv that is equal to half the vertical dimension of the light-guiding channel, and therefore substantially equal to half the vertical dimension of the entrance microlens 20 bounding one longitudinal end of this light-guiding channel. Moreover, the vertical dimension Dv is substantially equal to the vertical dimension of one exit microlens 24 bounding one longitudinal end of this light-guiding channel. The mask segment 231 extends vertically between a vertically upper edge 28 and a vertically lower edge 30.

Below, arbitrarily, the first aperture 261 is placed closer to the vertically lower edge 30 than to the vertically upper edge 28, the second aperture 262 for its part being placed closer to the vertically upper edge 28.

The first aperture 261 is bounded by a first border lying at a first distance D1 from the vertically upper edge 28 of this mask segment and a second border lying at a second distance D2 from this vertically upper edge 28, and the second aperture 262 is bounded by a first border lying at a third distance D3 from the vertically upper edge 28 of this mask segment and a second border lying at a fourth distance D4 from this vertically upper edge 28. In order for the apertures to be vertically offset from each other, the value of the first distance D1 is greater than the value of the fourth distance D4.

The mask 23 is formed by a juxtaposition of mask segments 231, with a vertically lower edge 30 of a mask segment coinciding with a vertically upper edge 28 of a neighboring mask segment as regards the juxtaposition in the vertical direction, and with lateral edges coinciding as regards the transverse juxtaposition (not shown here).

Other arrangements could be employed without departing from the context of the invention, the entrance microlenses for example having a staggered distribution, and the mask segments a corresponding distribution, so that one mask segment and its plurality of apertures is placed in the light-guiding channel defined downstream of one entrance microlens.

Moreover, one of the first or second apertures could have a vertical dimension equal to Dv, i.e. substantially equal to half the vertical dimension of the entrance microlens 20 bounding one longitudinal end of this light-guiding channel, or substantially equal to the vertical dimension of an exit microlens 24 bounding one longitudinal end of this light-guiding channel. Said aperture could furthermore have a horizontal dimension substantially equal to the horizontal dimension of the entrance microlens 20 bounding one longitudinal end of this light-guiding channel, or substantially equal to the horizontal dimension of an exit microlens 24 bounding one longitudinal end of this light-guiding channel. Thus, said aperture would then be bounded horizontally and/or vertically by the opaque portions 233 of the mask segments 231 of the adjacent light-guiding channels and/or the opaque portions 233 of the mask segments 231 associated with the other apertures of the same light-guiding channel.

As mentioned above, it is notable that the number of apertures 261, 262 formed in a given mask segment is equal to the number of different light sources 41, 42 associated with a given collimator 3, and equal to the number of luminous functions capable of being emitted through a given exit area, namely the array of exit microlenses 22 or indeed a given optical area of a projector located at the exit of the microlens array 2.

In the illustrated example, two types of apertures 26 are present and two luminous functions are performed by the luminous device 1 of the invention, the first light source 41 participating, when it is activated, in generating a first luminous function and the second light source 42 participating, when it is activated, in generating a second luminous function.

In the illustrated example, the first luminous function is a lighting function, and more particularly here a so-called “low beam”, i.e. a beam intended to provide illumination while not dazzling other road users. The second luminous function may be a position-light function, for which the power of the light source is decreased, or a signaling function and more particularly here a so-called “daytime running light”, i.e. a light intended to signal the presence of the vehicle.

Characteristics of the light sources 41, 42 and of the apertures 26 formed in the mask segments 231 depend on the luminous functions to be performed by the luminous device.

The light source associated with implementation of such and such a type of luminous function is thus selected depending on the luminous intensity that this luminous function must or must not have in order to comply with automotive-vehicle regulations. Moreover, as mentioned above, the position of a light source with respect to a defined plane comprising the main optical axis may depend on the luminous function to be performed and in particular on the sharpness of the outlines of the light beam to be delivered.

In particular, in the example of embodiment in which the first luminous function is a “low beam” and in which the second luminous function is a signaling function, the first light source 41 allowing the first luminous function to be performed may be closer to the defined plane than the second light source 42 allowing the second luminous function to be performed.

The apertures 26 have different positions on their common mask segment and they may have different shapes and dimensions from each other. In particular, in the example of embodiment in which the first luminous function is a “low beam”, and as in particular shown in FIG. 2, the first apertures 261 are bounded by a cutoff edge 32 containing a kink. This cutoff edge 32 aims to define, in the light beam projected from the exit of the microlens array, a particular shape making it possible to avoid causing road users required to pass the vehicle equipped with the luminous device discomfort glare. This cutoff edge 32 is the second edge that extends lying at a second distance D2 from the vertically upper edge 28 of the corresponding mask segment 231.

It will be noted that the apertures 26 could be inverted, at the same time as the placement of the light sources on either side of the defined plane, so as to place the second border of the first aperture, i.e. the cutoff edge 32 containing the kink, at the distance D4 and therefore closer to the optical axis, the projected image of this cutoff edge thus being sharpened.

In the illustrated example, the second apertures 262 are bounded by straight edges.

The luminous device 1 according to the invention is particular in that the light-emitting means 4 comprise a plurality of selectively addressable light sources 41, 42, in that the collimator common to these light sources reorients the emitted light rays into a beam of parallel rays that strikes each entrance microlens 20 at an angle of incidence specific to activation of such and such a light source and in that the apertures 26 provided in the mask segment 231 placed downstream of an entrance microlens 20 are placed so as to be selectively on the path of the rays transmitted by the entrance lens depending on activation of such and such a light source initially.

More particularly, a plurality of selectively addressable light sources 41, 42 are configured to illuminate the same array of entrance microlenses 21 via a common collimator 3. Each light source is placed in a theoretical position with respect to the collimator and to a defined plane, and the rays emitted by each light source are shaped into a beam of parallel rays specific to activation of such and such a light source, so that the rays emitted by a first light source strike an entrance microlens with a first angle of incidence and so that the rays emitted by a second light source strike the same entrance microlens with a second incidence angle.

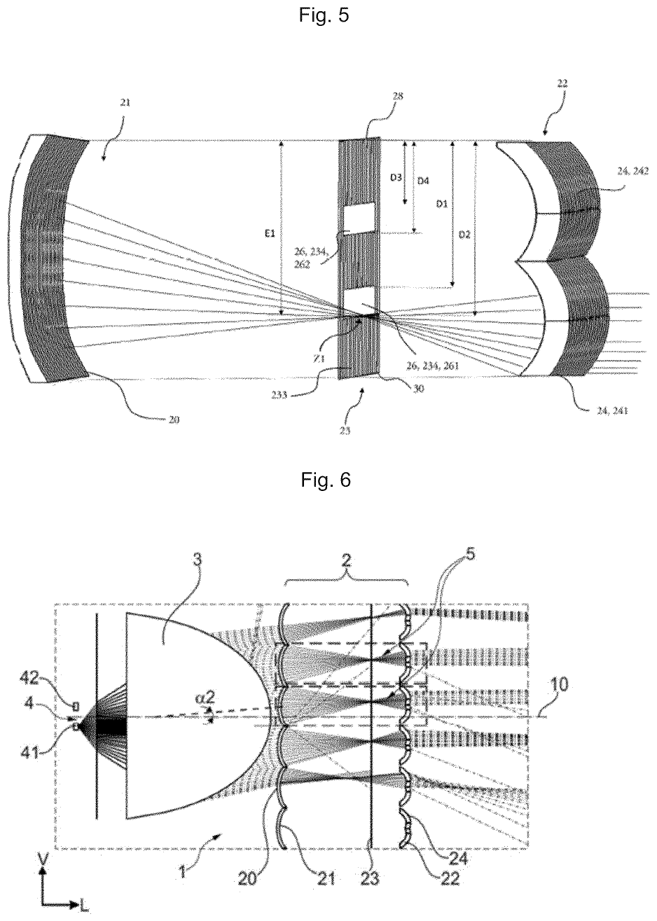

As a result of this arrangement, when a first light source 41 is active, the light rays strike the entrance microlenses with a first angle of incidence and the entrance microlenses 20 focus the light rays onto a first zone Z1 of the mask segment 231 that corresponds thereto. In other words, one entrance microlens 20 associated with one light-guiding channel 5 focuses the light rays emitted by the first light source 41 onto a first zone Z1 of the mask segment 231 arranged in this light-guiding channel, and another entrance microlens associated with another light-guiding channel focuses the light rays emitted by the first light source onto a first zone of the mask segment arranged in this other light-guiding channel. The first zone Z1 is located on the mask segment with a first spacing El (shown in FIG. 5) with respect to the vertically upper edge 28 of this mask segment. The apertures are configured such that one of the apertures, here the first aperture 261, is placed in this first zone Z1. More particularly here, the first aperture 261 is formed in the mask segment such that the cutoff edge 32 of this first aperture is placed in this first zone Z1.

It will be understood that, in the case where the first apertures are staggered, as mentioned with reference to FIG. 2, with columns of mask segments containing apertures in inverted positions, the corresponding entrance microlenses are configured to focus the light emitted by the first light source in an alternative first zone, corresponding to the position of a first aperture.

In this context, when the first light source 41 is activated, the light rays successively pass through the collimator and each of the entrance microlenses so as to propagate through each of the light-guiding channels and to pass through each of the first apertures 261 in the mask.

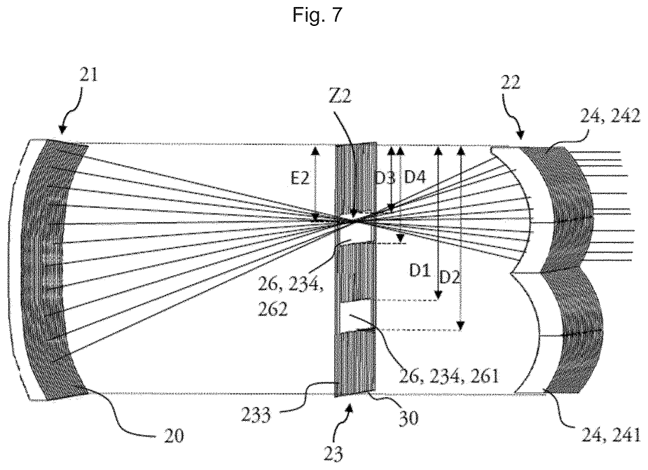

When the second light source 42 is activated instead of the first light source 41, because of the different position of these two light sources with respect to the collimator 3 and because of the different angle of incidence with which the rays shaped by the collimator strike the entrance microlenses 20 of the microlens array 2, the entrance microlenses 20 focus the light rays onto a second zone Z2 of the mask segment that corresponds thereto. In other words, one entrance microlens 20 associated with one light-guiding channel 5 focuses the light rays emitted by the second light source 42 onto a second zone Z2 of the mask segment 231 arranged in this light-guiding channel 5, and another entrance microlens associated with another light-guiding channel focuses the light rays emitted by the second light source onto a second zone of the mask segment arranged in this other light-guiding channel. The second zone Z2 is located on the mask segment with a second spacing E2 (shown in FIG. 7) with respect to the vertically upper edge 28 of this mask segment. The apertures are configured such that one of the apertures, here the second aperture 262, is placed in this second zone Z1. More particularly here, the second aperture 262 is formed in the mask segment such that the second zone Z2 is placed at the center of this second aperture.

Once again, it will be understood that, in the case where the second apertures are staggered, as mentioned with reference to FIG. 2, with columns of mask segments containing apertures in inverted positions, the corresponding entrance microlenses are configured to focus the light emitted by the second light source in an alternative second zone, corresponding to the position of a second aperture.

In this context, when the second light source 42 is activated, the light rays successively pass through the collimator and each of the entrance microlens so as to propagate through each of the light-guiding channels and to pass through each of the second apertures 262 in the mask.

According to the invention, two distinct light beams are thus projected onto the same lighting area, rays focused by the entrance microlenses 20 being made to pass through the first apertures 261 of the mask 23 when a first luminous function is desired, and rays focused by the entrance microlenses 20 being made to pass through the second apertures 262 of the mask 23 when a second luminous function is desired.

What was described above will now be illustrated through a more precise explanation, with reference to FIGS. 4 and 5, of the propagation of light rays emitted by the first light source, and then, subsequently, with reference to FIGS. 6 and 7, of the propagation of light rays emitted by the second light source.

FIGS. 4 and 5 illustrate the luminous device when the latter is performing a first luminous function, here a “low beam” lighting function.

The first light source 41 is turned on via suitable driving by an electronic control device associated with the luminous device. The first light source 41 emits rays in the direction of the collimator 3, and the latter collects these rays and directs them into a beam of rays that are parallel to one another, transmitted in the direction of the array of entrance microlenses of the microlens array 2.

The collimator 3 is configured such that, when the light rays are being generated by the first light source 41, these light rays emerge from the collimator 3 with a main tilt of a first angle al with respect to the main optical axis 10, while allowing as stated above for a slight divergence in the rays due to the fact that the source is not a point source. As a result thereof, the light rays strike each of the entrance microlens with a first angle of incidence. In this context, the light rays are deflected by each entrance microlens 20 so as to be focused on a first zone Z1 of the mask segment 231 placed across the light-guiding channel 5 (see FIG. 5). This first zone Z1 corresponds to the presence of a first aperture 261, such that the rays focused on this first zone Z1 are able to pass through the mask 23 in the direction of the array of exit microlenses. The exit microlens placed facing the first aperture 261 has an object focal point located in this first zone Z1, such that rays propagating through the first aperture in the direction of this exit microlens 24, here the first exit microlens 241, exit the microlens array substantially parallel to the optical axis of the exit microlens, and parallel to the main optical axis 10 of the luminous device.

As may be seen in FIG. 5 in particular, the first zone Z1 is located on the mask segment with a first spacing E1 with respect to the vertically upper edge 28 of this mask segment. The first zone Z1 corresponds to the presence of a first aperture 261 insofar as, considering the first distance D1 and second distance D2 associated with this first aperture 261 and mentioned above, the value of the first spacing E1 is between the value of the first distance D1 and the value of the second distance D2 defining the dimension of the first apertures. More particularly here, the value of the first spacing E1 is substantially equal to the value of the second distance, such that the first zone Z1, on which the light rays are focused when the first light source 41 is active, is located substantially on the second border of the first aperture forming the aforementioned cutoff edge 32.

As a result of the above, the light rays emitted by the first light source 41 propagate within the microlens array 2 through each of the light-guiding channels 5, in order to pass through the first apertures 261 provided in each mask segment 231. The exit microlenses placed downstream of these first apertures 261 are configured to deflect the light rays in the direction of the road on which the vehicle is being driven in order to form a light beam that will not generate discomfort glare.

FIGS. 6 and 7 illustrate the luminous device when the latter is performing a second luminous function, here a “daytime running light” signaling function.

The second light source 42 is turned on via suitable driving by an electronic control device associated with the luminous device. The second light source 42 emits rays in the direction of the collimator 3, and the latter collects these rays and directs them into a beam of rays that are parallel to one another, transmitted in the direction of the array of entrance microlenses of the microlens array 2.

The collimator 3 is configured such that, when the light rays are being generated by the second light source 42, these light rays emerge from the collimator 3 with a main tilt of a second angle α2 with respect to the main optical axis 10, once again while allowing as stated for a slight divergence in the rays due to the fact that the source is not a point source. As a result thereof, the light rays strike each of the entrance microlenses with a second angle of incidence. In this context, the light rays are deflected by each entrance microlens 20 so as to be focused on a second zone Z2 of the mask segment 231 placed across the light-guiding channel 5 (see FIG. 7). This second zone Z2 corresponds to the presence of a second aperture 262, such that the rays focused on this second zone Z2 are able to pass through the mask 23 in the direction of the array of exit microlenses. The exit microlens placed facing the second aperture 262 has an object focal point located in this second zone Z1, such that rays propagating through the second aperture in the direction of this exit microlens 24, here the second exit microlens 241, exit the microlens array substantially parallel to the optical axis of the exit microlens, and parallel to the main optical axis 10 of the luminous device.

As may be seen in FIG. 7 in particular, the second zone Z2 is located on the mask segment with a second spacing E2 with respect to the vertically upper edge 28 of this mask segment. The second zone Z2 corresponds to the presence of a second aperture 262 insofar as, considering the third distance D3 and fourth distance D4 associated with this second aperture 262 and mentioned above, the value of the second spacing E2 is between the value of the third distance D3 and the value of the fourth distance D4 defining the dimension of the second apertures. More particularly here, the value of the second spacing E2 is substantially a value equidistant between the values of the third and fourth distances, such that the second zone Z2, on which the light rays are focused when the second light source is active, is located substantially at the center of the second aperture 262, or at two thirds of its height as mentioned above, i.e. at a distance from the edge such that most of the rays that must pass through the aperture are not blocked on the fringes.

As a result of the above, the light rays emitted by the second light source 42 propagate within the microlens array 2 through each of the light-guiding channels 5, in order to pass through the second apertures 262 provided in each mask segment 231. The exit microlenses placed downstream of these second apertures 262 are configured to deflect the light rays into a signaling beam substantially parallel to the direction of the main optical axis 10.

It may be seen, in particular by comparing FIGS. 4 and 6, that the exit surface of the luminous device, here formed by the array of exit microlenses but which could be an optical surface of a projector placed downstream of the microlens array, is illuminated over a substantially identical extent irrespectively of whether the first luminous function, via activation of the first light source 41, or the second luminous function, via activation of the second light source 42, is being performed.

The invention such as has just been described achieves the objective set for it, i.e. it allows at least two different luminous functions to be performed by the same luminous module, while employing the same lighting area, i.e. the area through which the light rays exit remains of the same extent regardless of the luminous function being performed.

It will be understood that the configuration of the microlens array proposed by way of example could be different, provided that it allows the illuminated area to remain the same regardless of the luminous function being performed. By way of nonlimiting example, provision could be made, as mentioned, for a different alternation of the apertures in columns so as to stagger the apertures of a given type, and provision could be made for a luminous device that performs two different signaling functions, for example daytime running lights and direction-indicating lights, or indeed two different lighting functions, for example low-beam lights and a high-intensity luminous function participating in production of a “high beam”.

What is claimed is:

1. A luminous device comprising at least light-emitting means, a collimator and a microlens array, the light-emitting means being configured to emit light rays in the direction of the microlens array via the collimator, the microlens array includes at least an array of entrance microlenses, an array of exit microlenses, and a mask interposed between the two arrays of microlenses, the microlens array being configured to form light-guiding channels that are respectively arranged between at least one entrance microlens and one exit microlens, the mask includes mask segments that are each placed in one respective light-guiding channel, with the light-emitting means comprise including a plurality of selectively addressable light sources, the collimator being common to the plurality of light sources and configured to shape the light rays emitted by a light source into a beam of substantially parallel rays directed in the direction of the microlens array, a tilt angle of the beam of substantially parallel rays with respect to the optical axis differing depending on the light source activated, the at least one light-guiding channel is arranged along the main optical axis and is bounded at one longitudinal end by a single entrance microlens, which is configured to focus the beams of substantially parallel rays onto a focal zone on the mask segment, which is placed in the light-guiding channel and the position of which on the mask segment differs depending on the tilt angle of the beam of substantially parallel rays, the single entrance microlens thus being configured to direct the rays onto various focal zones depending on the tilt angle of the beam of substantially parallel rays, the mask segment placed in the at least one light-guiding channel includes a plurality of apertures each placed in a respective one of the focal zones.

2. The luminous device as claimed in the claim 1, wherein the at least one light-guiding channel is arranged along the main optical axis and is bounded at one longitudinal end by a single entrance microlens and at the other longitudinal end by a plurality of exit microlenses.

3. The luminous device as claimed in claim 2, wherein the exit microlenses placed at one longitudinal end of a light-guiding channel are adjacent.

4. The luminous device as claimed in claim 2, wherein the exit microlenses of a given light-guiding channel are configured to have object focal points positioned differently on the mask segment present in this light-guiding channel, an object focal point of an exit microlens being specifically associated with one aperture in the mask segment.

5. The luminous device as claimed in claim 2, wherein, within a light-guiding channel, the number of apertures that are different from one another within a mask segment is equal to the number of exit microlenses present at one longitudinal end of this light-guiding channel.

6. The luminous device as claimed in claim 1, wherein the number of apertures that are different from one another within a mask segment is equal to the number of different light sources.

7. The luminous device as claimed in claim 1, wherein the apertures present within a given mask segment, in a light-guiding channel, are of different shapes and/or sizes.

8. The luminous device as claimed in claim 7, wherein the pattern formed in a mask segment by the apertures of different shapes and/or sizes is identical for each mask segment.

9. The luminous device as claimed in claim 1, further comprising a first light source activation of which participates in generating a first luminous function and a second light source activation of which participates in generating a second luminous function or an additional segment of the first luminous function, light rays emitted by the first light source being intended to be focused by the entrance microlens of a light-guiding channel onto a first focal zone located on a first aperture of the mask segment that is placed in this light-guiding channel, light rays emitted by the second light source being intended to be focused by the same entrance microlens onto a second focal zone located on a second aperture of the same mask segment.

10. The luminous device as claimed claim 1, wherein each mask segment includes first apertures and second apertures associated with a first focal zone and a second focal zone, respectively, and that at least one of the first apertures and at least one of the second apertures has a different shape and/or size from the other first apertures and other second apertures.

11. The luminous device as claimed in claim 9, wherein the first light source and the second light source are spaced apart from each other, being distributed on either side of a defined plane, the first light source being closer to the defined plane than the second light source.

12. The luminous device as claimed in claim 2, wherein the object focal point of one of the exit microlenses specifically associated with a first aperture is placed substantially on a border bounding the first aperture.

13. The luminous device as claimed in claim 12, wherein the border of the first aperture, on which the object focal point of one of the exit microlenses is placed, contains a kink.

14. The luminous device as claimed in claim 9, wherein the object focal point of an exit microlens specifically associated with a second aperture is placed substantially at the center of the second aperture.

15. An automotive vehicle comprising at least one luminous device, the at least one luminous device includes at least light-emitting means, a collimator and a microlens array, the light-emitting means being configured to emit light rays in the direction of the microlens array via the collimator, the microlens array includes at least an array of entrance microlenses, an array of exit microlenses, and a mask interposed between the two arrays of microlenses, the microlens array being configured to form light-guiding channels that are respectively arranged between at least one entrance microlens and one exit microlens, the mask includes mask segments that are each placed in one respective light-guiding channel, with the light-emitting means including a plurality of selectively addressable light sources, the collimator being common to the plurality of light sources and configured to shape the light rays emitted by a light source into a beam of substantially parallel rays directed in the direction of the microlens array, a tilt angle of the beam of substantially parallel rays with respect to the optical axis differing depending on the light source activated, the at least one light-guiding channel is arranged along the main optical axis and is bounded at one longitudinal end by a single entrance microlens, which is configured to focus the beams of substantially parallel rays onto a focal zone on the mask segment, which is placed in the light-guiding channel and the position of which on the mask segment differs depending on the tilt angle of the beam of substantially parallel rays, the single entrance microlens thus being configured to direct the rays onto various focal zones depending on the tilt angle of the beam of substantially parallel rays, the mask segment placed in the at least one light-guiding channel includes a plurality of apertures each placed in a respective one of the focal zones.
